(19) United States
(12) Patent Application Publication
(10) Pub. No.: US 2010/0230331 A1
(43) Pub. Date: Sep. 16, 2010

(54) SOLID-LIQUID SEPARATION SYSTEM

(76) Inventors: Mii Fukuda, Tokyo (JP); Takashi Menju, Kawasaki-shi (JP); Yasushi Yamamoto, Yokohama-shi (JP); Kazuyoshi Aoki, Yokohama-shi (JP); Ichiro Yamanashi, Tokyo (JP); Tokusuke Hayami, Tokyo (JP); Kazuhiko Noda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/717,318

(22) Filed: Mar. 4, 2010

(30) Foreign Application Priority Data
Mar. 13, 2009 (JP) P2009-061420

(51) Int. Cl. C02F 1/38; C02F 1/52; C02F 1/66

(52) U.S. Cl. 210/96.1; 210/210; 210/199; 210/98; 210/197; 210/201

(57) ABSTRACT

An aggregating agent injector (13) injects into raw water an aggregating agent for aggregating solids in raw water, a first aggregation aid injector (16) injects into raw water with the aggregating agent injected therein an aggregation aid for hardening or consolidating flocs formed by the aggregating agent, and a centrifugal separator (18) has a flocculator portion for causing raw water with the aggregation aid injected therein to whirl therein to flocculate solids in raw water, and a solid collector portion for causing raw water to swirl at higher speeds than in the flocculator portion to separate flocs from raw water.

### CROSS REFERENCE TO RELATED APPLICATIONS

The present application claims the benefit of priority under 35 U.S.C. §119 to Japanese Patent Application No. 2009-061420, filed on Mar. 13, 2009, the entire contents of which are incorporated herein by reference.

### BACKGROUND OF THE INVENTION

1. Field of Art

The present invention relates to a solid-liquid separation system adapted to separate raw water into solids and liquid in a course of water treatment such as effluent treatment or water purification.

2. Description of Relevant Art

In water treatment such as effluent treatment or water purification, solids in raw water such as suspended matters and turbidity components are separated, typically by way of a settling separation. For instance, FIG. 1 shows a solid-liquid separation system 1 including a raw water pump 100 for sending raw water to be processed for treatment to an admixing vessel 101. At the admixing vessel 101, which has an admixer 102 installed therein, inflowing raw water is admixed together with an aggregating agent injected from an aggregating agent injector 103, and outflows to a reaction vessel 104. At the reaction vessel 104, which has a mixer 105 installed therein, inflowing raw water is mixed with an aggregation aid injected from an aggregation aid injector 106, and outflows to a flocculation vessel 107.

At the flocculation vessel 107, which has a flocculator 108 installed therein, inflowing raw water has clusters of suspended matters and turbidity components grown as flocs, and outflows, carrying grown flocs, to a gravity settling vessel 109. At the gravity settling vessel 109, flocs are settled down by way of using the gravity, to have supernatant water outflow as processed water.

That is, the solid-liquid separation system 1 makes use of specific gravity differences between water and flocs of suspended matters and turbidity components, for sedimentation of flocs greater in specific gravity than water to take a resultant supernatant liquid as processed water, thereby effecting a separation of raw water into solids (suspended matters, turbidity components) and liquid (processed water).

The typical solid-liquid separation system 1 described with reference to FIG. 1 requires raw water to have a long residence time in the flocculation vessel 107 for formation of flocs, with a resultant enlargement in capacity at the vessel 107. Further, due to the sedimentation of flocs being slow in speed, the system 1 requires raw water to have a long residence time in the gravity settling vessel 109 also, with a resultant enlargement in capacity at the vessel 109. Such being the case, conventional solid-liquid separation systems employing such a gravity settling as described have needed a long time for treatment and a wide space secured for installation.

In recent years, there have been solid-liquid separation systems using an inclined plate or inclined pipes for enhancement in efficiency of separation aiming at a reduced treatment time. However, even those systems using an inclined plate or inclined pipes have had their limitations in enhancement of separation efficiency or reduction of treatment time, still needing a wide space secured for installation.

There has been a liquid cyclone disclosed in Japanese Patent Application Laid-Open Publication No. 2004-313900 (referred herein to as JP 2004-313900 A) as a configuration making use of centrifugal forces to separate solids greater than a prescribed particle diameter, affording to have an enhanced efficiency of separation with a reduced installation space. The liquid cyclone is configured for causing raw water to swirl inside, to spin down or surface solids therein, making use of centrifugal forces thereof, permitting an enhanced speed of processing, and is adapted for application to provide a reduced capacity of settling equipment, allowing for a reduced installation space, in comparison with gravity settling vessels.

Generally, the liquid cyclone is adapted for separation of solids greater than a nominal particle diameter, but inadaptable to separate minute solids from liquid simply by use of the gravity. In the solid-liquid separation system 1 described with reference to FIG. 1, there are supports including injection of an aggregating agent by the aggregating agent injector 13 and injection of an aggregation aid by the aggregation aid injector 106, for flocculation of minute and light-weight solids to make such solids clustered into greater sizes and heavier weights, thereby enabling a sedimentation at the gravity settling vessel 109.

Raw water carrying flocs might have been introduced into such a liquid cyclone as disclosed in the JP2004-313900 A. However, flocs would have been torn by shearing forces produced by raw water swirling in the liquid cyclone. That is, there are flocs formed by suspended matters or the like in raw water, which tend to be torn into such particle diameters that the liquid cyclone is unable to separate, as an issue. In other words, conventional liquid cyclones have been unavailable for separation of minute solids needing a flocculation. As a result, there has been the necessity for provision of such a gravity settling vessel as described with reference to FIG. 1, thus needing a long processing time and a wide space secured for system installation.

It is an object of the present invention to provide a solid-liquid separation system allowing for an enhanced efficiency of separation with a reduced processing time, and a reduced installation space.

### SUMMARY OF THE INVENTION

To solve the object described, according to the present invention, there is a solid-liquid separation system adapted to work, as raw water containing solids inflows, to separate raw water into solids and liquid, the solid-liquid separation system comprising, an aggregating agent injector configured to inject into raw water an aggregating agent adapted to aggregate solids in raw water, a first aggregation aid injector configured to inject into raw water with the aggregating agent injected therein, an aggregation aid adapted to harden or consolidate flocs formed by the aggregating agent, and a centrifugal separator configured with a flocculator portion to cause raw water with the aggregation aid injected therein to whirl therein to flocculate solids in raw water, and a solid collector portion to cause raw water to swirl at higher speeds than in the flocculator portion to separate flocs from raw water.

### BRIEF DESCRIPTION OF THE DRAWINGS

FIG. 1 is a diagram of a typical solid-liquid separation system.

FIG. 2 is a diagram of a solid-liquid separation system according to a first embodiment.

FIG. 3 is a diagram of a centrifugal separator of the solid-liquid separation system in FIG. 2.

FIG. 4 is a diagram of a solid-liquid separation system according to a second embodiment.

FIG. 5 is a diagram of a solid-liquid separation system according to a third embodiment.

FIG. 6 is a diagram of a solid-liquid separation system according to a fourth embodiment.

FIG. 7 is a plot of exemplary control data used in the solid-liquid separation system in FIG. 6.

FIG. 8 is a diagram of a solid-liquid separation system according to a modification of the fourth embodiment.

FIG. 9 is a diagram of a solid-liquid separation system according to a fifth embodiment.

FIG. 10 is a plot of exemplary control data used in the solid-liquid separation system in FIG. 9.

FIG. 11 is a diagram of a solid-liquid separation system according to a modification of the fifth embodiment.

FIG. 12 is a diagram of a solid-liquid separation system according to a sixth embodiment.

FIG. 13 is a diagram of a solid-liquid separation system according to a seventh embodiment

FIG. 14 is a diagram of a solid-liquid separation system according to a modification of the seventh embodiment.

### DETAILED DESCRIPTION OF THE EMBODIMENTS

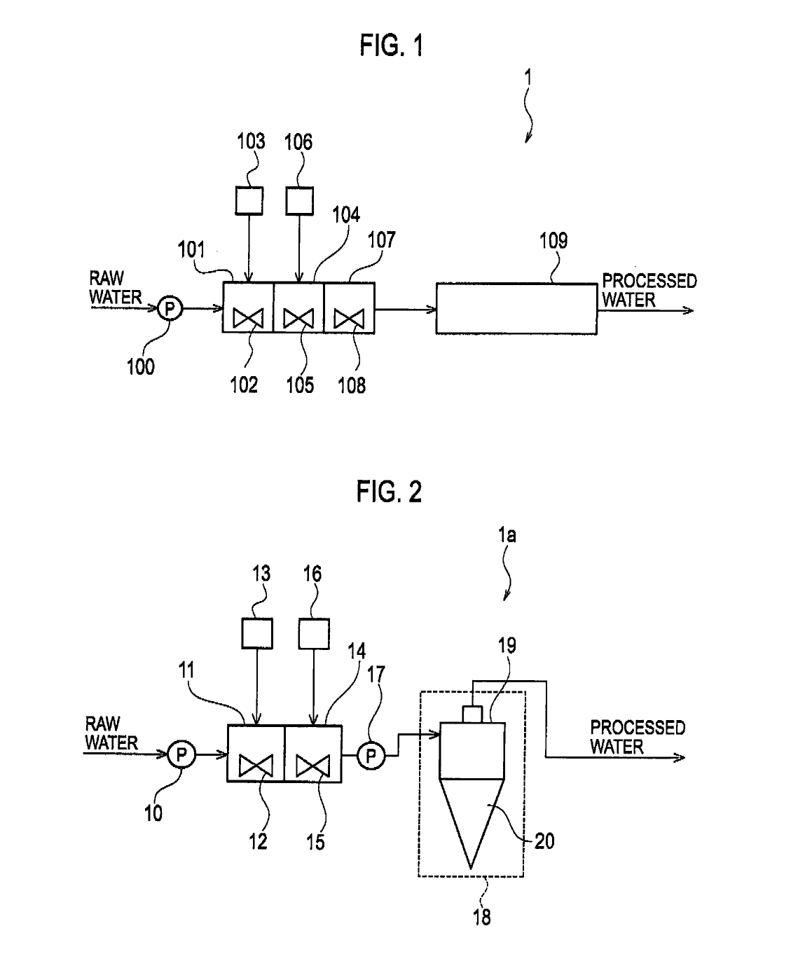

There will be described a respective one of solid-liquid separation systems according to embodiments of the present invention with reference to the drawings. According to the present invention, the solid-liquid separation system is implemented as equipment for a water treatment, such as an effluent treatment or water purification, in which raw water that includes solids such as suspended matters (referred herein sometimes collectively simply to as suspended matters) is separated into solids and liquid, like the conventional solid-liquid separation system 1 described above with reference to FIG. 1. Like elements are designated by like reference characters, for description with eliminated redundancy.

### First Embodiment

Referring to FIG. 2, according to a first embodiment of the present invention, a solid-liquid separation system 1a includes: an admixing vessel 11 in which raw water is introduced through a raw water pump 10; an aggregating agent injector 13 configured to inject an aggregating agent into raw water; a reaction vessel 14 in which raw water having been admixed together with the aggregating agent at the admixing vessel 11 is introduced; an aggregation aid injector 16 configured to inject into raw water an aggregation aid adapted to harden and/or consolidate flocs formed by the aggregating agent; and a centrifugal separator 18 in which raw water including clusters of solids (suspended matters) aggregated by the aggregating agent is introduced, and caused to swirl therein, to separate raw water into liquid (as water processed for treatment) and solids (as flocculated clusters of suspended matters aggregated by the aggregating agent).

The aggregating agent injector 13 is configured to inject, into raw water in the admixing vessel 11, an aggregating agent adapted to clamp together solids contained in raw water. The aggregating agent used may be an inorganic flocculant, such as poly aluminum chloride, alum or aluminum sulfate, ferric chloride, or the like. The kind of aggregating agent to be selected depends on a combination of associated conditions, such as type and amount of suspended matters in raw water, as well as charged state, and is determined by the solid-liquid separation system 1a itself in accordance with raw water being processed for treatment.

The admixing vessel 11 has an admixer 12 installed therein to admix raw water in the vessel 11. At the admixing vessel 11, raw water is admixed by the admixer 12 together with the aggregating agent, to cause solids such as suspended matters in raw water to be aggregated to grow into flocs by an aggregation effect of the aggregating agent.

The aggregation aid injector 16 is configured to inject, into raw water in the reaction vessel 14, an aggregation aid adapted to harden and/or consolidate flocs being formed by aggregation effect of the aggregating agent. The aggregation aid used may be an organic high-molecular flocculant such as polyacrylamide. The kind of aggregation aid to be selected depends on a combination of associated conditions, such as type and amount of solids in raw water, and is determined by the solid-liquid separation system 1a itself in accordance with raw water being processed for treatment. The aggregation aid injected by the aggregation aid injector 16 is used not simply for promotion of aggregation, but also for the principal purpose of hardening and/or consolidating flocs formed by aggregation. Hardened flocs have hardened surfaces with reduced tendencies to be broken. Consolidated flocs have stronger binding forces with reduced tendencies to be torn.

The reaction vessel 14 has a first mixer 15 installed therein for a mixing of raw water in the vessel 14. At the reaction vessel 14, raw water is mixed with the aggregation aid by the first mixer 15, to cause solids in raw water to grow into harder and/or stronger flocs than in formation at the admixing vessel 11, for enhancement in durability of flocs.

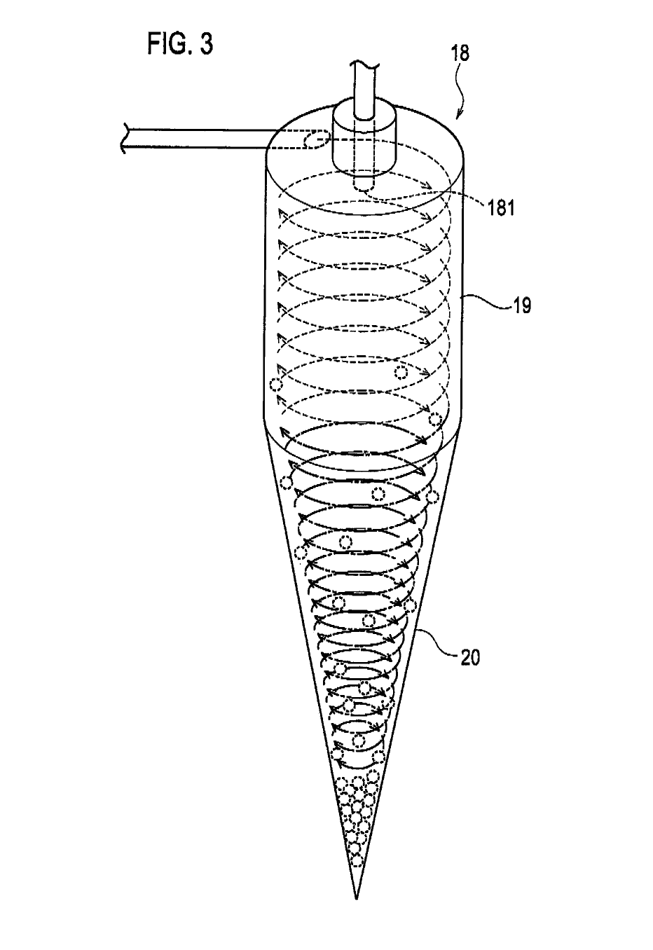

The centrifugal separator 18 is configured, as illustrated in FIG. 3, for instance, in appearance of a typical liquid cyclone adapted to work for circulation of inflowing raw water, with: a flocculator portion 19 of a cylindrical shape; and a solid collector portion 20 of a conical shape joined in a unit with the flocculator portion 19. The flocculator portion 19 is longer in height than the diameter, whereby raw water therein can be whirled at low speeds. The solid collector portion 20 is profiled with a taper side at an angle to a lateral side of the flocculator portion 19, which may preferably be set within an angular range of 15 to 20 degrees, in order for raw water in the solid collector portion 20 to be caused to swirl at higher speeds than whirling speeds of raw water in the flocculator portion 19. The solid-liquid separation system 1a is configured for control in flow rate of raw water inflowing into the centrifugal separator 18, as well as with adjustments such as in diameter of an inlet pipe of raw water, to have raw water inflow at adequate velocities, to provide swirl currents (with centrifugal forces) sufficient in momentum to separate from raw water in the solid collector portion 20 those flocs that have been formed at the flocculator portion 19 or upstream.

As described, raw water is sent through the water pump 17 to the flocculator portion 19, where it whirls to spin, causing flocs to grow. At the flocculator portion 19, raw water is whirled not at high speeds, but at low speeds that provide small flocs in raw water with higher tendencies to collide with each other, allowing for larger grown flocs. Further, at the flocculator portion 19, inflowing raw water includes the aggregation aid having been mixed therewith upstream, so at low speeds it is afforded to have an adequate residence time secured for formation of floccds, which permits flocs formed in the flocculator portion 19 to be harder, stronger, and more endurable than flocs formed in raw water free of aggregation aid would be.

In the solid collector portion 20, raw water swirls to spin at higher speeds than in the flocculator portion 19, so those flocs greater in specific gravity than water are spun down due to centrifugal forces and the gravity. In order for the separation to be efficient at the solid collector portion 20, incoming flocs should have been grown enough, so that flocs in swirling water can be prevented from being torn into minute fragments by shearing forces acting thereon. In this respect, the flocculator portion 19 is configured to spin raw water at low speeds, causing flocs to collide with each other, to grow to greater diameters, while aiding by the aggregation aid to grow into hard, strong, and endurable flocs, allowing for an enhanced efficiency of separation at the solid collector portion 20.

The centrifugal separator 18 is thus adapted to separate raw water into solids and liquid by settling down flocs. The flocculator portion 19 has a processed water outlet 181 formed at a top thereof for sending out supernatant liquid of raw water as processed water after the settling of flocs. In the solid-liquid separation system 1a, separation is effected between solids and liquid as processed water, which is taken out through the processed water outlet 181.

It is noted that the embodiment described has employed a liquid cyclone as the centrifugal separator 18, but instead, for separation between solids and liquid, it may employ any centrifugal separator else, e.g. decanter or the like. In such the case, it however is provided that the centrifugal separator else than the liquid cyclone includes a flocculator portion configured to have inflowing raw water whirled to spin for growth of flocs, and a solid collector portion configured to have raw water swirled to spin with grown flocs therein at higher speeds than in the flocculator portion, for collection of flocs.

As will be seen from the foregoing description, according to the first embodiment, the solid-liquid separation system 1a is configured to inject into raw water an aggregation aid adapted to form hard, strong, and endurable flocs. Accordingly, the solid-liquid separation system 1a is adapted to work, even when raw water is swirled, to keep flocs in raw water from being torn by shearing forces, thus permitting flocs to be collected by a centrifugal separator 18, with a shorter floc collection time than by a gravity settling, allowing for an enhanced efficiency of separation.

In the solid-liquid separation system 1a, the centrifugal separator 18 has a flocculator portion 19 incorporated therein to grow flocs to greater diameters. Accordingly, flocs have increased tendencies to be collected at a solid collector portion 20 of the centrifugal separator 18, still allowing for an enhanced efficiency of separation.

In the solid-liquid separation system 1a, the centrifugal separator 18 is configured to generate swirling currents for use of centrifugal forces combined with the gravity to spin down flocs with a shorter floc settling time than a conventional settling simply using the gravity, yet allowing for an enhanced efficiency of separation.

Further, in the solid-liquid separation system 1a, which injects into raw water an aggregating agent adapted to form endurable flocs, there is use of a single unit configured as the centrifugal separator 18 working to effect both flocculation and solid collection, which substitutes for the combination of a flocculation vessel and a gravity-settling vessel individually adapted for similar functions that conventional solid-liquid separation systems have necessitated to achieve similar effects, thus allowing for the system 1a to implement a simplified configuration with a saved space for installation.

### Second Embodiment

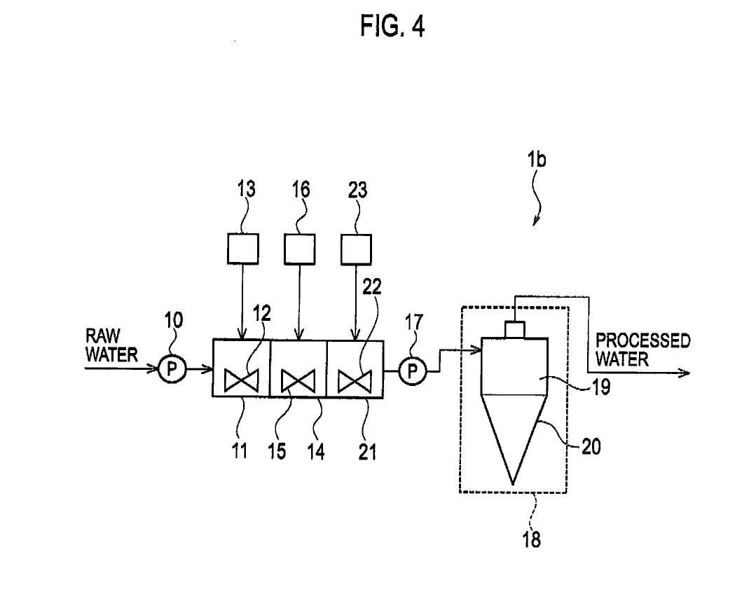

Referring to FIG. 4, according to a second embodiment of the present invention, there is a solid-liquid separation system 1b different from the solid-liquid separation system 1a according to the first embodiment described with reference to FIG. 2, in that it includes a subsystem comprised of a second reaction vessel 21, a second mixer 22, and a second aggregation aid injector 23, in addition to that system including a reaction vessel 14 (referred herein to as a first reaction vessel), a mixer 15 (referred herein to as a first mixer), and an aggregation aid injector 16 (referred herein to as a first aggregation aid injector). The solid-liquid separation system 1b includes a centrifugal separator 18 receiving raw water sent through a water pump 17, whereto raw water is inlet from the second reaction vessel 21, not from the first reaction vessel 14.

The second aggregation aid injector 23 is configured to inject, into raw water in the second reaction vessel 21, an aggregation aid adapted to harden, consolidate, and/or enlarge flocs being formed in raw water by aggregation effect of an aggregating agent mixed therewith upstream. The aggregation aid injected may also be an organic high-molecular flocculant such as polyacrylamide. The second aggregation aid injector 23 is adapted, by such injection of the aggregation aid, to serve for more effective hardening, consolidation, and/or enlargement of flocs than injection of an aggregation aid simply by the first aggregation aid injector 16. The aggregation aid injected by the second aggregation aid injector 23 may or may not be identical in type to the aggregation aid the first aggregation aid injector 16 has injected.

In other words, there may be injection of an aggregation aid for hardening flocs at the first aggregation aid injector 16, followed by injection of an aggregation aid for consolidating flocs at the second aggregation aid injector 23, to thereby harden and consolidate flocs. Or else, there may be injection of an aggregation aid for hardening flocs at the first aggregation aid injector 16, followed by injection of an aggregation aid for enlarging flocs at the second aggregation aid injector 23, to thereby harden and enlarge flocs.

The second reaction vessel 21 has the second mixer 22 installed therein. At the second reaction vessel 21, the second mixer 22 is configured to mix raw water, the aggregating agent, and the aggregation aids together, affording to cluster solids in raw water into more endurable and/or enlarged flocs than flocs formed in the first reaction vessel 14. With more enhanced durability, flocs have more decreased tendencies to be torn, allowing for a still enhanced rate of solid collection at a solid collector portion 20 of the centrifugal separator 18. Still more, enlarged flocs have increased tendencies to be collected at the solid collector portion 20, allowing for the more enhanced rate of solid collection.

As will be seen from the foregoing description, according to the second embodiment, the solid-liquid separation system 1b is adapted to inject an aggregation aid by a second aggregation aid injector 23 for enhancement of separation efficiency.

Further, according to the second embodiment, the solid-liquid separation system 1b permits implementation of a simplified system with a saved space, allowing for an enhanced efficiency of separation, like the solid-liquid separation system 1a according to the first embodiment.

### Third Embodiment

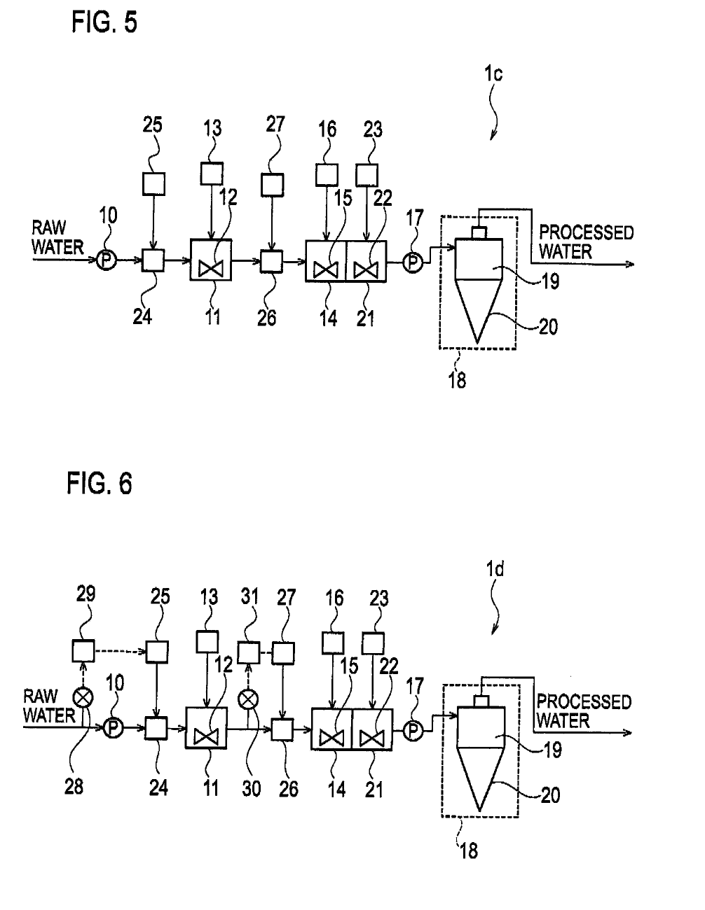

Referring to FIG. 5, according to a third embodiment of the present invention, there is a solid-liquid separation system 1c different from the solid-liquid separation system 1b according to the second embodiment described with reference to FIG. 3, in that it includes combination of: a subsystem installed upstream of an admixing vessel 11 and comprised of a first control vessel 24, and a first adjuster injector 25 configured to inject an adjuster into raw water before injection of an aggregating agent; and a subsystem installed downstream of the admixing vessel 11 and upstream of a first reaction vessel 14 and comprised of a second control vessel 26, and a second adjuster injector 27 configured to inject an adjuster into raw water after injection of the aggregating agent and before injection of an aggregation aid. In the solid-liquid separation system 1c, raw water is let to run from the admixing vessel 11 to the first reaction vessel 14, through the second control vessel 26.

The first adjuster injector 25 is configured to inject, into raw water in the first control vessel 24, an adjuster such as an acid or alkali adapted (as a pH adjuster) to control the pH of raw water within an adequate control range of pH for the aggregating agent to be active with an enhanced aggregation effect.

The first control vessel 24 is configured to outlet raw water to the admixing vessel 11, with a pH controlled by the adjuster injected by the first adjuster injector 25.

The second adjuster injector 27 is configured to inject, into raw water in the second control vessel 26, an adjuster such as an acid or alkali adapted (as a pH adjuster) to control the pH of raw water within an adequate control range of pH for the aggregation aid to be active for an enhanced aggregation effect.

The second control vessel 26 is configured to outlet raw water to the first reaction vessel 14, with a pH controlled by the adjuster injected by the second adjuster injector 27.

As will be seen from the foregoing description, according to the third embodiment, the solid-liquid separation system 1c is configured with a pair of adjuster injectors 25 and 27 adapted for injection of adjusters to provide raw water with an optimal pH for aggregation. Accordingly, the solid-liquid separation system 1c permits formation of flocs to be optimized for separation with an enhanced aggregation effect, allowing for an enhanced efficiency of separation.

Further, according to the third embodiment, the solid-liquid separation system 1c permits implementation of a simplified system with a saved space, allowing for an enhanced efficiency of separation, like the solid-liquid separation system 1a according to the first embodiment.

It is noted that in FIG. 5 the solid-liquid separation system 1c may well exclude a subsystem comprised of a second reaction vessel 21 provided with a second mixer 22, and a second aggregation aid injector 23. The solid-liquid separation system 1c has the subsystem being installed upstream of the admixing vessel 11 and comprised of the first control vessel 24 and the first adjuster injector 25, and the subsystem being installed upstream of the first reaction vessel 14 and comprised of the second control vessel 26 and the second adjuster injector 27, and may well exclude either adjuster injector. The solid-liquid separation system 1c has the second adjuster injector 27 installed upstream of the first reaction vessel 14, and may well have another adjuster injector installed upstream of the second reaction vessel 21.

### Fourth Embodiment

Referring to FIG. 6, according to a fourth embodiment of the present invention, there is a solid-liquid separation system 1d different from the solid-liquid separation system 1c according to the third embodiment described with reference to FIG. 5, in that it includes combination of: a subsystem comprised of a first pH meter 28 configured to measure a pH of raw water before injection of an adjuster by a first adjuster injector 25, and a first pH controller 29 configured to control a dose of the adjuster to be injected by the first adjuster injector 25 in accordance with a measure of pH at the first pH meter 28; and a subsystem comprised of a second pH meter 30 configured to measure a pH of raw water after injection of an aggregating agent and before injection of an adjuster by a second adjuster injector 27, and a second pH controller 31 configured to control a dose of the adjuster to be injected by the second adjuster injector 27 in accordance with a measure of pH at the second pH meter 30.

The first pH meter 28 is configured as means such as a pH sensor for measuring a pH of raw water. The first pH meter 28 is installed upstream of a first control vessel 24, to measure a pH of raw water flowing into the first control vessel 24. That is, the first pH meter 28 is adapted to measure a pH of raw water before injection of a pH adjuster preceding injection of an aggregating agent.

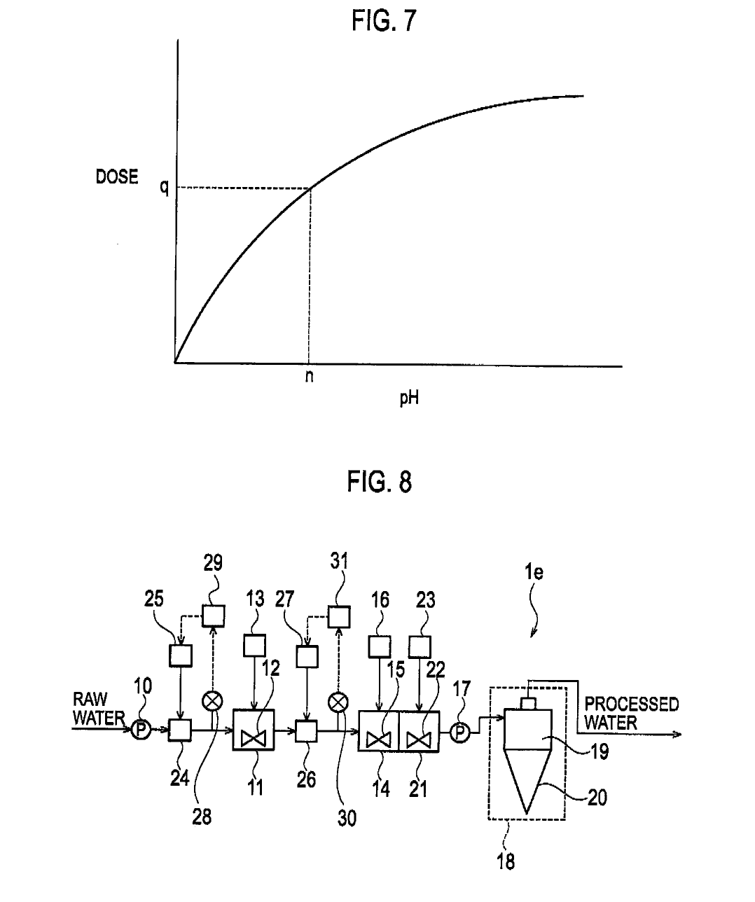

The first pH controller 29 is configured to work, as a measure of pH by the first pH meter 28 is input, to output a control signal to the first adjuster injector 25, to cause to inject into the first control vessel 24 an adequate dose of adjuster for a pH to be set to afford to optimize an aggregation effect of the aggregating agent in accordance with the input measure of pH. In other words, the first pH controller 29 is adapted to use a measure of pH by the first pH meter 28 for a feed-forward control of the first adjuster injector 25. FIG. 7 shows an example of relationship between a pH (n) of raw water and a dose (q) of adjuster to be injected. The first pH controller 29 has stored therein a set of expressions or tables representing such relationships, and is adapted to determine a dose of injection corresponding to an input pH, to output a signal for commensurate control.

The second pH meter 30 is configured as means such as a pH sensor for measuring a pH of raw water. The second pH meter 30 is installed downstream of an admixing vessel 11 and upstream of a second control vessel 26 to measure a pH of raw water flowing into the second control vessel 26. That is, the second pH meter 30 is adapted to measure a pH of raw water after injection of the aggregating agent.

The second pH controller 31 is configured to work, as a measure of pH by the second pH meter 30 is input, to output a control signal to the second adjuster injector 27, to cause to inject into the second control vessel 26 an adequate dose of adjuster for a pH to be set to afford to optimize effects of the aggregation aid in accordance with the input measure of pH. In other words, the second pH controller 31 is adapted to use a measure of pH by the second pH meter 30 for a feed-forward control of the second adjuster injector 27. Like the first pH controller 29, the second pH controller 31 also has stored therein a set of expressions or tables representing relationships between pH of raw water and dose of adjuster, and is adapted to determine a dose of injection corresponding to an input pH, to output a signal for commensurate control.

As will be seen from the foregoing description, according to the fourth embodiment, the solid-liquid separation system 1d is configured with a pair of adjuster injectors 25 and 27 adapted to inject adequate doses of adjusters in accordance with measures of pH of raw water. Accordingly, the solid-liquid separation system 1d can prevent over- or under-injection of adjuster for formation of flocs, allowing for an enhanced efficiency of separation.

Further, according to the fourth embodiment, the solid-liquid separation system 1d permits implementation of a simplified system with a saved space, allowing for an enhanced efficiency of separation, like the solid-liquid separation system 1c according to the third embodiment.

It is noted that in FIG. 6 the solid-liquid separation system 1d may well have simply one of the subsystem comprised of the first pH meter 28 and the first pH controller 29 and the subsystem comprised of the second pH meter 30 and the second pH controller 31. Further, the solid-liquid separation system 1d may well simply have a subsystem comprised of a first reaction vessel 14 provided with a first mixer 15, and a first aggregation aid injector 16, excluding a subsystem comprised of a second reaction vessel 21 provided with a second mixer 22, and a second aggregation aid injector 23.

### Modification of the Fourth Embodiment

Referring to FIG. 8, according to a modification of the fourth embodiment, there is a solid-liquid separation system 1e different from the solid-liquid separation system 1d according to the fourth embodiment described with reference to FIG. 6, in that it includes a first pH meter 28 installed downstream of a first control vessel 24, and a second pH meter 30 installed downstream of a second control vessel 26.

The first pH meter 28 is configured to measure a pH of raw water that has been pH-controlled at the first control vessel 24. There is a first pH controller 29 adapted to work, as a measure of pH by the first pH meter 28 is input, for a feedback control of a first adjuster injector 25 in accordance with the input measure of pH. The first pH controller 29 has stored therein a set of expressions or tables representing such relationships between pH (n) of raw water and optimum dose (q) of adjuster to be injected in accordance therewith, as described with reference to FIG. 7 as an example, and is adapted to determine a dose of injection corresponding to an input pH, to output a signal for commensurate control.

The second pH meter 30 is configured to measure a pH of raw water that has been pH-controlled at the second control vessel 26. There is a second pH controller 31 adapted to work, as a measure of pH by the second pH meter 30 is input, for a feedback control of a second adjuster injector 27 in accordance with the input measure of pH. Like the first pH controller 29, the second pH controller 31 also has stored therein a set of expressions or tables representing relationships between pH of raw water and optimum dose of adjuster to be injected in accordance therewith, and is adapted to determine a dose of injection corresponding to an input pH, to output a signal for commensurate control.

As will be seen from the foregoing description, according to the modification of the fourth embodiment, the solid-liquid separation system 1e is configured with a pair of adjuster injectors 25 and 27 adapted to inject adequate doses of adjusters in accordance with measures of pH of raw water. Accordingly, the solid-liquid separation system 1e can prevent over- or under-injection of adjuster for formation of flocs, allowing for an enhanced efficiency of separation.

Further, according to the modification of the fourth embodiment, the solid-liquid separation system 1e permits implementation of a simplified system with a saved space, allowing for an enhanced efficiency of separation, like the solid-liquid separation system 1d according to the fourth embodiment.

It is noted that in FIG. 8 the solid-liquid separation system 1e may well have simply one of a subsystem comprised of the first pH meter 28 and the first pH controller 29 and a subsystem comprised of the second pH meter 30 and the second pH controller 31. Further, the solid-liquid separation system 1e may well simply have a subsystem comprised of a first reaction vessel 14 provided with a first mixer 15, and a first aggregation aid injector 16.

### Fifth Embodiment

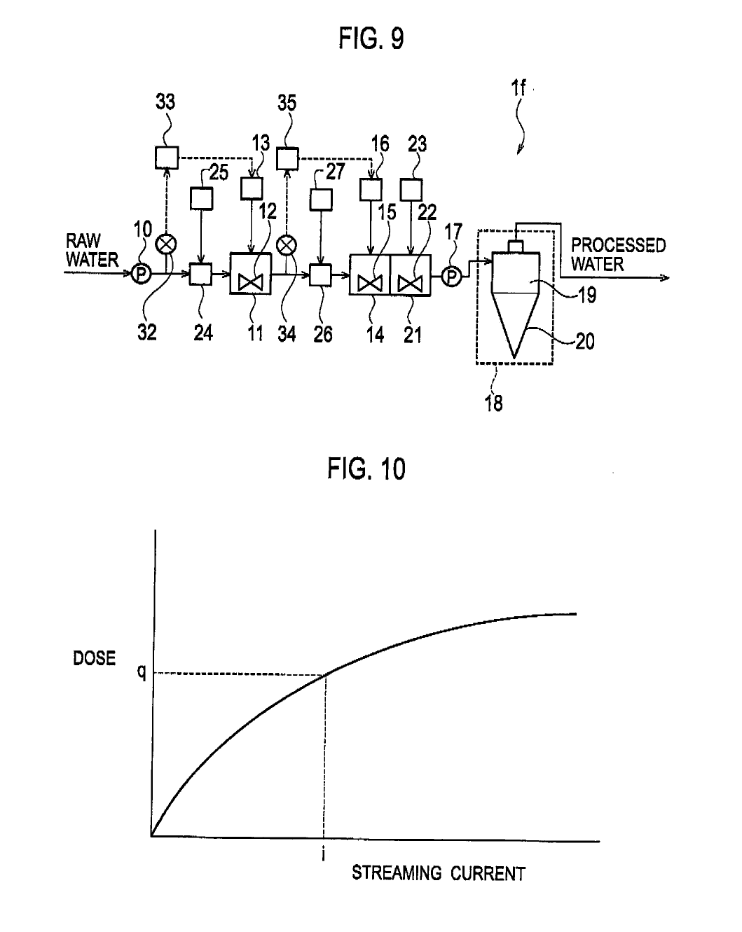

Referring to FIG. 9, according to a fifth embodiment of the present invention, there is a solid-liquid separation system 1f different from the solid separation system 1c according to the third embodiment described with reference to FIG. 5, in that it further includes a combination of: a subsystem comprised of a first streaming current meter 32 configured to measure a streaming current of raw water flowing into a first control vessel 24, and an aggregating agent injection controller 33 configured to control a dose of injection of an aggregating agent by an aggregating agent injector 13 in accordance with a measure of streaming current at the first streaming current meter 32; and a subsystem comprised of a second streaming current meter 34 configured to measure a streaming current of raw water after injection of the aggregating agent and before injection of an adjuster by a second adjuster injector 27, and an aggregation aid injection controller 35 configured to control a dose of injection of an aggregation aid by a first aggregation aid injector 16 in accordance with a measure of streaming current at the second streaming current meter 34.

The first streaming current meter 32 is configured as a current meter to measure a streaming current of raw water. It is installed upstream of the first control vessel 24, to measure a streaming current of raw water being sent to the first control vessel N. That is, the first streaming current meter 32 is adapted to measure a streaming current of raw water before injection of the adjuster of pH preceding injection of the aggregating agent.

The aggregating agent injection controller 33 is configured to work, as a measure of streaming current by the first streaming current meter 32 is input, to output a control signal to the aggregating agent injector 13, to cause to inject into an admixing vessel 11 an adequate dose of aggregating agent for formation of flocs in accordance with the input measure of streaming current. In other words, the aggregating agent injection controller 33 is adapted to use a measure of streaming current by the first streaming current meter 32 for a feed-forward control of the aggregating agent injector 13.

FIG. 10 shows an example of relationship between a streaming current (i) of raw water and a dose (q) of aggregating agent to be injected. The aggregating agent injection controller 33 has stored therein a set of expressions or tables representing such relationships, and is adapted to determine a dose of injection corresponding to an input streaming current, to output a signal for commensurate control.

The second streaming current meter 34 is configured as a current meter to measure a streaming current of raw water. It is installed upstream of a second control vessel 26, to measure a streaming current of raw water being sent to the second control vessel 26. That is, the second streaming current meter 34 is adapted to measure a streaming current of raw water after injection of the aggregating agent.

The aggregation aid injection controller 35 is configured to work, as a measure of streaming current by the second streaming current meter 34 is input, to output a control signal to the first aggregation aid injector 16, to cause to inject into a first reaction vessel 14 an adequate dose of aggregation aid for formation of flocs in accordance with the input measure of streaming current. In other words, the aggregation aid injection controller 35 is adapted to use a measure of streaming current by the second streaming current meter 34 for a feed-forward control of the first aggregation aid injector 16.

Like the aggregating agent injection controller 33, the aggregation aid injection controller 35 also has stored therein a set of expressions or tables representing relationships between measure of streaming current and dose of injection of aggregation aid, and is adapted to determine a dose of injection corresponding to an input streaming current, to output a signal for commensurate control.

According to the fifth embodiment, the solid-liquid separation system 1f has an aggregating agent injector 13 configured for injection of an adequate dose of aggregating agent in accordance with a streaming current of raw water. The system 1f further has a first aggregation aid injector 16 configured for injection of an adequate dose of aggregation aid in accordance with a streaming current of raw water. Accordingly, the solid-liquid separation system 1f can prevent over- or under-injection of aggregating agent for formation of flocs, allowing for an enhanced efficiency of separation. Further, the system 1f can prevent over- or under-injection of aggregation aid for formation of flocs, allowing for an enhanced efficiency of separation.

Further, according to the fifth embodiment, the solid-liquid separation system 1f permits implementation of a simplified system with a saved space, allowing for an enhanced efficiency of separation, like the solid-liquid separation system 1c according to the third embodiment.

It is noted that in FIG. 9 the solid-liquid separation system 1f may well have simply one of the subsystem comprised of the first streaming current meter 32 and the aggregating agent injection controller 33 and the subsystem comprised of the second streaming current meter 34 and the aggregation aid injection controller 35.

Further, in FIG. 9, the solid-liquid separation system 1f may well simply have a subsystem comprised of a first reaction vessel 14 provided with a first mixer 15, and the first aggregation aid injector 16, unlike the second embodiment shown in FIG. 4 that further includes a subsystem comprised of a second reaction vessel 21 provided with a second mixer 22, and a second aggregation aid injector 23.

Still more, the solid-liquid separation system 1f that includes a pair of control vessels 24 and 26 and a pair of adjuster injectors 25 and 27 in FIG. 9 may well exclude the pair of control vessels 24 and 26 and the pair of adjuster injectors 25 and 27.

### Modification of the Fifth Embodiment

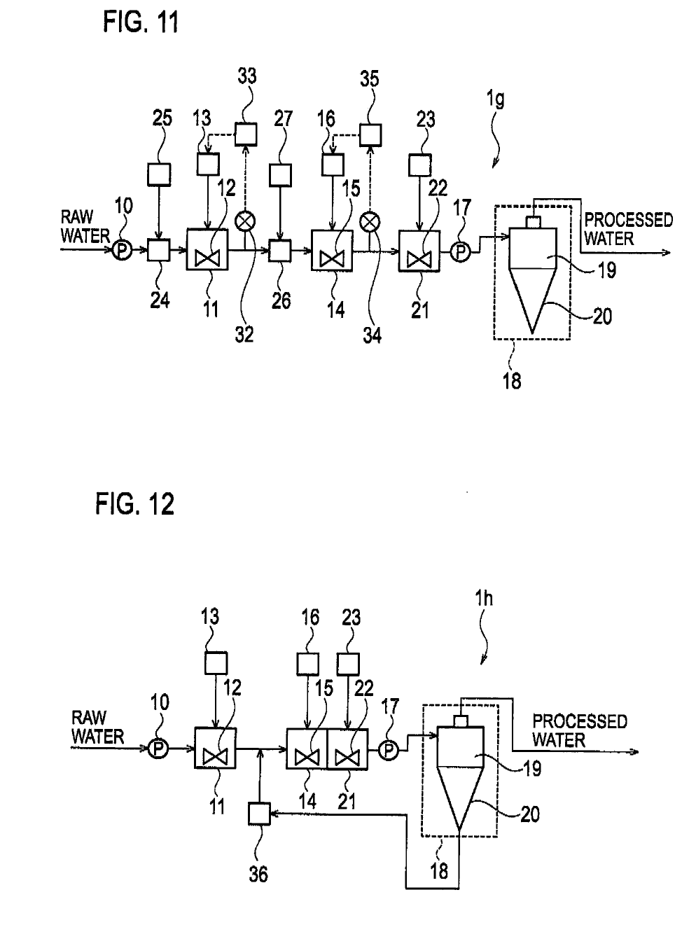

Referring to FIG. 11, according to a modification of the fifth embodiment, there is a solid-liquid separation system 1g different from the solid-liquid separation system 1f according to the fifth embodiment described with reference to FIG. 9, in that it includes a combination of a first streaming current meter 32 installed downstream of an admixing vessel 11, and a second streaming current meter 34 installed downstream of the admixing vessel 11 and upstream of a second reaction vessel 21.

The first streaming current meter 32 is configured to measure a streaming current of raw water that has been admixed together with an aggregating agent at the admixing vessel 11. There is an aggregating agent injection controller 33 adapted to work, as a measure of streaming current by the first streaming current meter 32 is input, for a feedback control of an aggregating agent injector 13 in accordance with the input measure of streaming current. The aggregating agent injection controller 33 has stored therein a set of expressions or tables representing such relationships between streaming current (i) of raw water and dose (q) of aggregating agent, as described with reference to FIG. 10 as an example, and is adapted to determine a dose of injection corresponding to an input measure of streaming current, to output a signal for commensurate control.

The second streaming current meter 34 is configured to measure a streaming current of raw water that has been mixed with an aggregation aid at a first reaction vessel 14. There is an aggregation aid injection controller 35 adapted to work, as a measure of streaming current by the second streaming current meter 34 is input, for a feedback control of a first aggregation aid injector 16 in accordance with the input measure of streaming current. Like the aggregating agent injection controller 33, the aggregation aid injection controller 35 also has stored therein a set of expressions or tables representing relationships between streaming current of raw water and dose of aggregation aid, and is adapted to determine a dose of injection corresponding to an input measure of streaming current, to output a signal for commensurate control.

As will be seen from the foregoing description, according to the modification of the fifth embodiment, the solid-liquid separation system 1g has an aggregating agent injector 13 configured for injection of an adequate dose of aggregating agent in accordance with a streaming current of raw water. The system 1g further has a first aggregation aid injector 16 configured for injection of an adequate dose of aggregation aid in accordance with a streaming current of raw water. Accordingly, the solid-liquid separation system 1g can prevent over- or under-injection of aggregating agent, allowing for an enhanced efficiency of separation. Further, the system 1g can prevent over- or under-injection of aggregation aid, allowing for an enhanced efficiency of separation.

Further, according to the modification of the fifth embodiment, the solid-liquid separation system 1g permits implementation of a simplified system with a saved space, allowing for an enhanced efficiency of separation, like the solid-liquid separation system 1f according to the fifth embodiment.

It is noted that in FIG. 11 the solid-liquid separation system 1g may well have simply one of a subsystem comprised of the first streaming current meter 32 and the aggregating agent injection controller 33 and a subsystem comprised of the second streaming current meter 34 and the aggregation aid injection controller 35. Further, the solid-liquid separation system 1g may well simply have a subsystem comprised of the first reaction vessel 14 provided with a first mixer 15, and the first aggregation aid injector 16. Still more, the solid-liquid separation system 1g may well exclude a pair of control vessels 24 and 26 and a pair of adjuster injectors 25 and 27.

### Sixth Embodiment

Referring to FIG. 12, according to a sixth embodiment of the present invention, there is a solid-liquid separation system 1h different from the solid-liquid separation system 1b according to the second embodiment described with reference to FIG. 4, in that it includes a floc circulator 36.

The floc circulator 36 is configured to work, as flux of flocs separated (as solids) at a centrifugal separator 18 inflows thereto, to return such flocs to raw water being processed for treatment. That is, the centrifugal separator 18 separates flocs, which are returned at least in part to the floc circulator 36, where they are supplied for circulation to raw water to be mixed with an aggregation aid, thereby adapting a second reaction vessel 21 to provide large and strong flocs. In this regard, flocs may be supplied to any position on the way of raw water from an admixing vessel 11 to the second reaction vessel 21, and the floc circulator 36 may supply flocs to raw water in the admixing vessel 11, a first reaction vessel 14, or the second reaction vessel 21.

As will be seen from the foregoing description, according to the sixth embodiment, the solid-liquid separation system 1h has a floc circulator 36 configured to return, to raw water, flux of floc collected by a centrifugal separator 18. Accordingly, in the solid-liquid separation system 1h, suspended matters and turbidity materials in raw water are aggregated onto circulated flocs, thus forming harder and stronger flocs, allowing for an enhanced efficiency of separation.

Further, according to the sixth embodiment, the solid-liquid separation system 1h permits implementation of a simplified system with a saved space, allowing for an enhanced efficiency of separation, like the solid-liquid separation system 1b according to the second embodiment.

### Seventh Embodiment

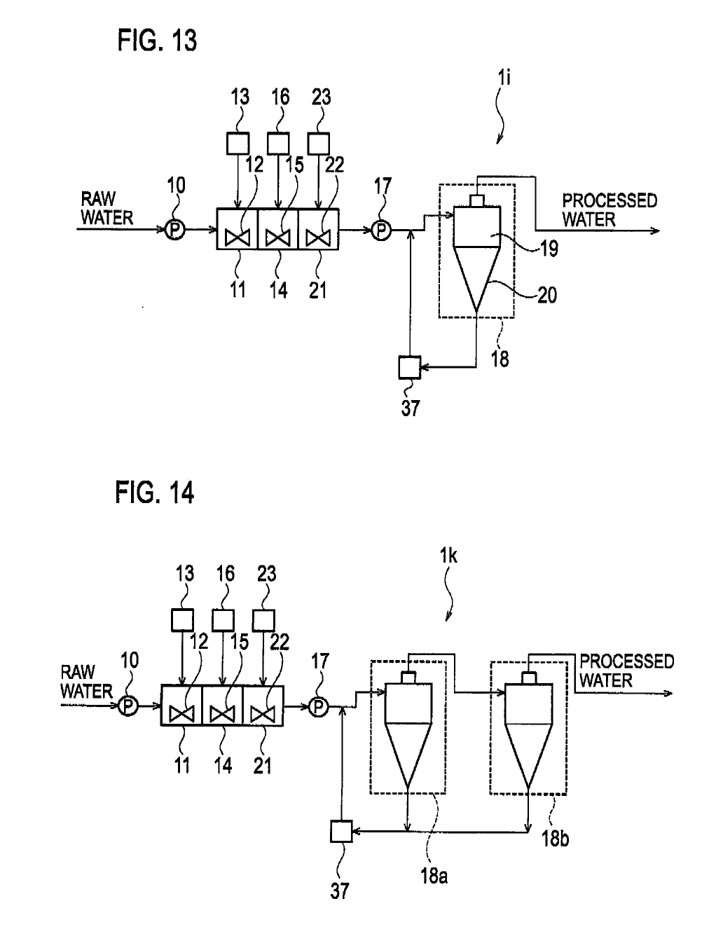

Referring to FIG. 13, according to a seventh embodiment of the present invention, there is a solid-liquid separation system 1i different from the solid-liquid separation system 1b according to the second embodiment described with reference to FIG. 4, in that it includes a floc circulator 37.

The floc circulator 37 is configured to work, as flux of flocs separated (as solids) at a centrifugal separator 18 inflows thereto, to return such flocs to raw water on the way of flowing out of a second reaction vessel 21, to be sent to the centrifugal separator 18. This provides a desirable efficiency of separation for a state of solid-liquid separation process at the centrifugal separator 18 processing raw water of a concentration of suspended matters within a range of about 100 to 1,000 ppm. Hence, the floc circulator 37 is adapted to add flocs to raw water when the turbidity of raw water is low.

As will be seen from the foregoing description, according to the seventh embodiment, the solid-liquid separation system 1i has a floc circulator 37 configured to return to raw water flux of floc collected by a centrifugal separator 18, for circulation to control the concentration of suspended matters in raw water, allowing for an enhanced efficiency of separation.

Further, according to the seventh embodiment, the solid-liquid separation system 1i permits implementation of a simplified system with a saved space, allowing for an enhanced efficiency of separation, like the solid-liquid separation system 1b according to the second embodiment.

### Modification of the Seventh Embodiment

Referring to FIG. 14, according to a modification of the seventh embodiment, there is a solid-liquid separation system 1k different from the solid-liquid separation system 1i according to the seventh embodiment described with reference to FIG. 13, in that it includes a pair of first and second centrifugal separators 18a and 18b.

In the solid-liquid separation system 1k also, the first and second centrifugal separators 18a and 18b are each configured, as illustrated in FIG. 3, with a flocculator portion 19 and a solid collector portion 20.

The solid-liquid separation system 1k using the two centrifugal separators 18a and 18b is adapted to separate at the second centrifugal separator 18b such suspended matters or the like that the first centrifugal separator 18a has failed to separate, thus allowing for an enhanced efficiency of separation.

It is noted that the smaller in size either centrifugal separator 18a, 18b is the smaller flocs the separator can collect. Accordingly, the second centrifugal separator 18b may well be formed smaller in size than the first centrifugal separator 18a, with an enhanced efficiency of separation.

What is claimed is:

1. A solid-liquid separation system adapted to work, as raw water containing solids inflows, to separate raw water into solids and liquid, the solid-liquid separation system comprising:
an aggregating agent injector configured to inject into raw water an aggregating agent adapted to aggregate solids in raw water;
a first aggregation aid injector configured to inject into raw water with the aggregating agent injected therein, an aggregation aid adapted to harden or consolidate flocs formed by the aggregating agent; and
a centrifugal separator configured with a flocculator portion to cause raw water with the aggregation aid injected therein to whirl therein to flocculate solids in raw water, and a solid collector portion to cause raw water to swirl at higher speeds than in the flocculator portion to separate flocs from raw water.

2. The solid-liquid separation system according to claim 1, comprising a second aggregation aid injector configured to inject into raw water with the aggregation aid injected therein by the first aggregation aid injector, an aggregation aid adapted to harden, consolidate, or cluster flocs.

3. The solid-liquid separation system according to claim 1, comprising:
a first adjuster injector configured to inject an adjuster for pH adjustment into raw water before injection of the aggregating agent; and
an admixer configured to admix raw water together with the adjuster injected by the first adjuster injector.

4. The solid-liquid separation system according to claim 2, comprising:
a first adjuster injector configured to inject an adjuster for pH adjustment into raw water before injection of the aggregating agent; and
an admixer configured to admix raw water together with the adjuster injected by the first adjuster injector.

5. The solid-liquid separation system according to claim 2, comprising:
a second adjuster injector configured to inject an adjuster for pH adjustment into raw water after injection of the aggregating agent before injection of the aggregation aids; and
an admixer configured to admix raw water together with the adjuster injected by the second adjuster injector.

6. The solid-liquid separation system according to claim 3, comprising:
a first pH meter configured to measure a pH of raw water before or after injection of the adjuster by the first adjuster injector; and
a first adjuster controller configured to control a dose of the adjuster to be injected by the first adjuster injector in accordance with a measure of pH at the first pH meter.

7. The solid-liquid separation system according to claim 4, comprising:
a first pH meter configured to measure a pH of raw water before or after injection of the adjuster by the first adjuster injector; and
a first adjuster controller configured to control a dose of the adjuster to be injected by the first adjuster injector in accordance with a measure of pH at the first pH meter.

8. The solid-liquid separation system according to claim 5, comprising:
a first pH meter configured to measure a pH of raw water before or after injection of the adjuster by the first adjuster injector; and
a first adjuster controller configured to control a dose of the adjuster to be injected by the first adjuster injector in accordance with a measure of pH at the first pH meter.

9. The solid-liquid separation system according to claim 5, comprising:
a second pH meter configured to measure a pH of raw water before or after injection of the adjuster by the second adjuster injector; and
a second adjuster controller configured to control a dose of the adjuster to be injected by the second adjuster injector in accordance with a measure of pH at the second pH meter.

10. The solid-liquid separation system according to claim 1, comprising:
a first streaming current meter configured to measure a streaming current of raw water before or after injection of the aggregating agent by the aggregating agent injector; and
an aggregating agent controller configured to control a dose of the aggregating agent to be injected by the aggregating agent injector in accordance with a measure of streaming current at the first streaming current meter.

11. The solid-liquid separation system according to claim 1, comprising:
a second streaming current meter configured to measure a streaming current of raw water before or after injection of the aggregation aid by the first aggregation aid injector; and
an aggregation aid controller configured to control a dose of the aggregation aid to be injected by the first aggregation aid injector in accordance with a measure of streaming current at the second streaming current meter.

12. The solid-liquid separation system according to claim 1, comprising a circulator configured to collect flocs settled in the centrifugal separator, and return collected flocs to raw water running with the aggregating agent injected therein or raw water running to inflow into the centrifugal separator.

13. The solid-liquid separation system according to claim 1, comprising a sequence of consecutive stages of centrifugal separators, with said centrifugal separator inclusive, including a posterior stage of centrifugal separator configured for solid-liquid separation of raw water separated as processed water at an anterior stage of centrifugal separator.
